(19) United States
(12) Patent Application Publication
(10) Pub. No.: US 2009/0195400 A1
(43) Pub. Date: Aug. 6, 2009

(54) ZIPPER WARNING ALARM SYSTEM

(76) Inventor: Viktor Oreshkin, Seattle, WA (US)

Correspondence Address: PERKINS COIE LLP;PATENT-SEA, P.O. BOX 1247, SEATTLE, WA, 98111-1247, US

(21) Appl. No.: 12/258,356

(22) Filed: Oct. 24, 2008

Related U.S. Application Data
(60) Provisional application No. 60/982,517, filed on Oct. 25, 2007.

(51) Int. Cl. G08B 21/00

(52) U.S. Cl. 340/686.1

(57) ABSTRACT

A zipper warning alarm system is described, wherein an operator is warned when a predetermined link of a zipper is not closed. Sensors may be placed in links of the zipper and can communicate to the alarm system whether the predetermined link is in contact with the opposing link in the bar tack. The alarm issues a warning to a user informing that the zipper is not closed

### CROSS-REFERENCE TO RELATED APPLICATION(S)

This application claims priority to, and incorporates by reference in its entirety, U.S. Provisional Application No. 60/982,517, filed on Oct. 25, 2007.

### TECHNICAL FIELD

This invention relates generally to the field of zippers and zipper warning systems. In particular, this invention relates to zipper warning alarm systems that can provide a warning or alert regarding the position of the zipper.

### BACKGROUND

An open zipper may create numerous unfavorable circumstances for the operator of a zipper who is unaware that the zipper is not fully closed. For example, an operator who is unaware that their handbag or wallet is not fully zipped closed is vulnerable to a security breach. Additionally, an open zipper may pose a risk in the health care industry. A medical device, for example, that is not fully secured due to an open zipper may result in damage or contamination of the device. Furthermore, an open zipper may cause personal embarrassment in the case of clothing, as commonly occurs for example with a pair of trousers. The zipper warning alarm system solves the frequent problem of unawareness of an open zipper by alerting the operator to close an open zipper. The operator becomes aware of the open zipper upon being prompted by an alarm or signal.

### SUMMARY

The present disclosure is directed to a zipper warning alarm system, wherein the operator is warned when a predetermined link of the zipper is not closed. Sensors, such as electrical and waterproof conduits, may be embedded in the predetermined link (i.e., tooth) in the zipper. The sensors may be powered by a low voltage battery, such as a lithium or hand watch type. The battery may be located within the zippers locking mechanism, which is usually located at one end of the zipper (e.g. a button, clasp, or double closing loop). For example, in the case of trousers, the battery would be located in the button or fastening loop at one end of the zipper. The zipper warning alarm system also includes an alarm mechanism, which is in communication with the sensors. When the sensors determine that the predetermined link is not closed, the sensors communicate with the alarm mechanism. The alarm mechanism then alerts the operator, for example by emitting a sound or vibration to indicate that the zipper is not fully closed.

### BRIEF DESCRIPTION OF THE DRAWINGS

FIG. 1 is an illustration of a zipper and warning system in accordance with an embodiment of the invention.

FIG. 2 is an illustration of a zipper for use with an embodiment of the invention, including a zipper, a bar tack, a plurality of sensors, a battery, and an alarm device, in accordance with an embodiment of the present invention.

### DETAILED DESCRIPTION

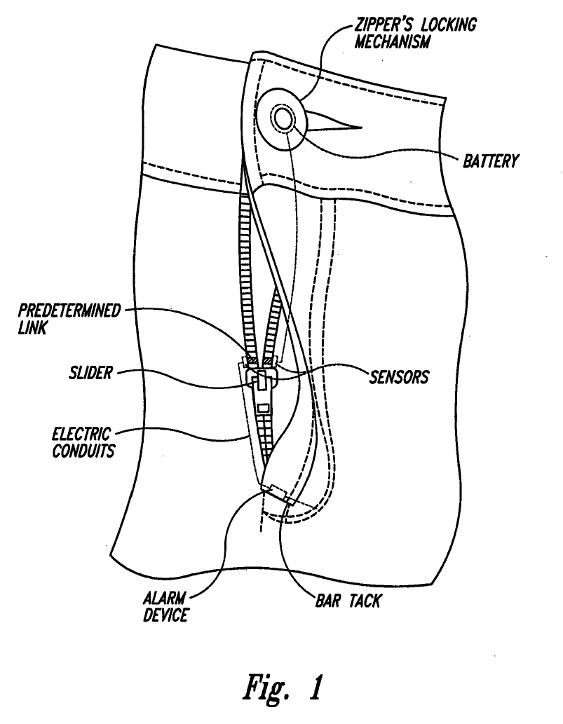

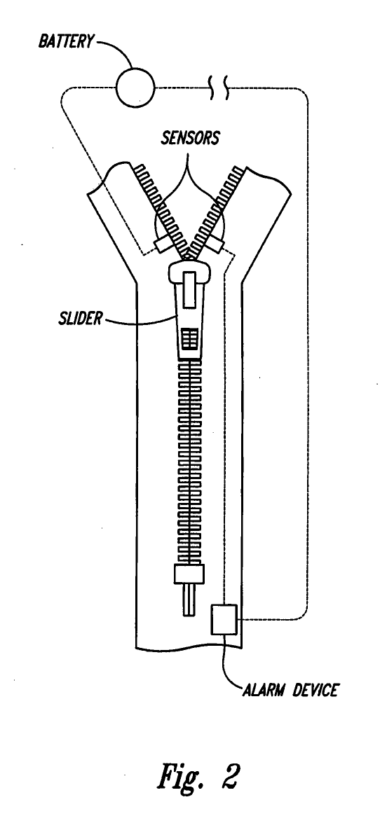

FIGS. 1 and 2 depict an embodiment of the present invention with the zipper and alarm system employed in a pair of trousers. It is to be appreciated by one of ordinary skill in the art that aspects of this invention can be practiced with equal success in a variety of environments. The zipper warning alarm system operates when the locking mechanism of the zipper is in the fastened position (i.e. when the pants are buttoned) and the zipper is open below the predetermined link. Activation of the sensors is created by the locking of the locking mechanism (i.e. fastening the button). If the predetermined zipper link is not closed or when the zipper's slider unfastens the predetermined zipper link, the sensors prompt the alarm mechanism to alert the operator that the zipper is open. The system is designed to be inoperable and no alarm will sound when the locking mechanism of the zipper is in an open or unlocked state.

A wide variety of signals or alerts may be generated by the alarm mechanism, depending on the operator's or maker's preference. For example, the alarm mechanism may emit a sound, vibration, or electric shock; send a page to a remote device; or other alarm indicia alone or in combination with the aforementioned. Additionally, the location, size, or type of battery used to power the system may vary. For example, the battery may be located in or near the alarm mechanism rather than in the locking mechanism. Furthermore, the type and size of sensors may vary, including but not limited to conduits, waterproof cables, fibers, or new conductive materials. In addition, the predetermined link at which the sensors evaluate whether or not the zipper is open can be programmed at different locations in the zipper.

The description of embodiments of the invention is not intended to be exhaustive or to limit the invention to the precise form disclosed. While specific embodiments of, and examples for, the invention are described herein for illustrative purposes, various equivalent modifications are possible within the scope of the invention, as those skilled in the relevant art will recognize. For example, while certain features are presented above in a given order, alternative embodiments may include such features in a different relationship than that described above. The teachings of the invention provided herein can be applied to other products, not only the zipper warning alarm system described herein. The various embodiments described herein can be combined to provide further embodiments. Further, aspects of the invention can be modified, if necessary, to employ the features described above in yet further embodiments. These and other changes can be made in the invention in light of the above detailed description.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

I/We claim:

1. A zipper warning system, comprising
a zipper, comprising:
a bar tack with a first row of links and a second row of links; and
a slider that travels along the bar tack from a first end to a second end, wherein moving the slider from the first end to the second end fastens the first row of links to the second row of links, and moving the slider from the second end to the first end unfastens the first row of links from the second row of links;
a zipper locking mechanism at the first end of the bar tack that activates the zipper warning system when locked;
an alarm system connected to at least one link in the bar tack by at least one electrical conduit, the alarm system issues an alarm based on a relative position of the slider and at least one predetermined link.

2. The zipper warning system of claim 1, further comprising at least a sensor placed in the predetermined link that detects whether the first row of links is fastened to the second row of links.

3. The zipper warning system of claim 1, the alarm system is connected to a first link in the first row of links and a first link in the second row of links, the alarm system issues the alarm based on contact between the first link and the second link.

4. The zipper warning system of claim 1, the predetermined link is located at the first end of the bar tack.
